(19) United States
(12) Patent Application Publication
(10) Pub. No.: US 2006/0124622 A1
(43) Pub. Date: Jun. 15, 2006

(54) Welding torch with a drive unit and a wire buffer store

(76) Inventors: Manfred Hubinger, Kremsmunster (AT); Martin Trausner, Sattledt (AT)

Correspondence Address: WILLIAM COLLARD;COLLARD & ROE, P.C., 1077 NORTHERN BOULEVARD, ROSLYN, NY, 11576, US

(21) Appl. No.: 10/559,507

(22) PCT Filed: May 4, 2004
(86) PCT No.: PCT/AT04/00152

§ 371 Date: Dec. 5, 2005

(30) Foreign Application Priority Data
Jul. 3, 2003 (AT) A 10222/2003

(51) Int. Cl. B23K 9/12

(52) U.S. Cl. 219/137.31

(57) ABSTRACT

The invention relates to a welding torch with a torch body and a drive unit, for supplying a welding wire, in particular, for differing wire feed speeds, or a forward/backward wire feed and a tube assembly, connected to the torch body at an angle to a mid axis of the welding torch, whereby a wire core, for the welding wire, or the welding wire itself follows a curved course to form a wire buffer store and the amount of the welding wire contained in the wire buffer store can be adjusted by changing the curved course. According to the invention, a welding torch may be produced which is as simple and compact in construction as possible with an improved dynamic property for the wire feed, whereby the wire buffer store is arranged directly after the region of the connection of the tube assembly within the torch body and the tube assembly is arranged at an angle of 33 to 90° to the mid axis of the welding torch.

The invention relates to a welding torch including a torch body and a drive unit for conveying a welding wire, particularly for different wire-conveying speeds or a forward/rearward wire conveyance, as well as a hose pack connected to the torch body at an angle relative to a central axis of said welding torch, wherein a wire core for the welding wire, or the welding wire itself, follows a curved course to form a wire buffer storage, and the amount of welding wire contained in the wire buffer storage is adjustable by a change of said curved course.

The welding wire is transported, particularly at different wire conveying speeds or in different conveying directions, via a drive unit usually arranged within the torch housing. The drive unit may, however, also be arranged outside the torch housing in a separate module or in an isolated part of the torch housing.

The most recent welding techniques, in which the welding wire is no longer conveyed only at a constant speed and in one direction, but forward and backward movements or different conveying speeds of the welding wire are applied for the ignition of the electric arc and/or during the welding process, great emphasis is placed on wire feeding. Because of different wire speeds and/or conveying directions of the welding wire, current wire conveying systems involve the problem of the welding wire conveyance response behavior being rather sluggish, thus preventing the achievement of optimum welding results. This is due to the fact that an excess of welding wire will result in the wire conveying system from different conveying speeds, or at a forward/rearward conveyance of the welding wire, which excess wire, according to the prior art, must be returned into a wire buffer storage over the entire hose pack.

From DE 197 38 785 C2, a device for electric-arc welding using a consumable electrode is, for instance, known, in which the welding wire is supplied to the welding site from a feed drum via two wire feeds. In that context, a short-circuit welding process by which the welding wire conveyance carries out a droplet transfer-supporting movement prior to the completion of the droplet formation is described, which means that the welding wire is pulled back by the wire feeder at the occurrence of a short-circuit and subsequently is again moved forwards after having reached a predetermined distance, said welding wire being transported in a wire buffer. There is, however, no hint as to the configuration of the wire buffer.

From DE 38 27 508 A1, a transport device is known, by which the welding wire is conveyed with a constant force even at unfavorable force introductions, while avoiding tensile and compressive stresses. The welding wire is conducted through an evading part and a curved hose between a push wire feeder arranged within the welding apparatus or a wire feeding means, and a pull wire feeder preferably arranged in the region of the welding torch or within the welding torch itself. The hose tension is supported by a spring. The evadable part is coupled to a control organ which measures the evasion path of the evading part at the occurrence of compressive or tensile stresses on the welding wire and supplies it to a control system for compensation via an automatic speed control of the first feeder. In that solution, the welding wire is unwound from the feed drum via the first wire feeder and introduced into a hose or wire core. The wire core is subsequently arranged to lay bare, forming the wire buffer storage in the form of a loop in that bare region with the loop being able to deform in that bare region, which means that the loop is increased or reduced, thus enabling more or less welding wire to be taken up. After this, the wire core is introduced into the hose pack to extend as far as to the further wire feeder preferably arranged in the region of the welding torch or within the welding torch itself.

Another wire puffer configuration is known from DE 43 20 405 C2, which describes a device for the slip-free conveyance of a welding wire. There, a wire buffer storage or wire buffer is again formed between two wire feeders and configured in a manner that the welding wire forms a complete wire loop before being introduced into the hose pack. The wire buffer storage is, thus, formed by a loop between two spaced-apart plates whose mutual distance is larger than the diameter of the welding wire. A sensor detecting the diameter of the loop of the welding wire is arranged to monitor the filling level of the wire buffer.

The above-described systems involve the disadvantage of requiring a lot of space for that kind of wire buffer or wire buffer storage, thus permitting a reasonable application only in the region of the welding apparatus or wire feeder, or as a separate device. It is, therefore, necessary to convey the welding wire from the wire buffer over the entire hose pack to the welding torch and back again to the wire buffer storage. Hence result large friction losses and relatively poor wire conveyance response behaviors. Such friction losses and the great sluggishness in wire feeding are caused by the fact that with known wire conveying means the welding wire runs in a wire core which is inserted in a guide tube, preferably in the hose pack, with the inner diameter of the guide tube being only negligibly larger than the outer diameter of the wire core. Thus, the precise guidance of the wire core is ensured, yet it is necessary for the welding wire, for instance at a reversal of the conveying direction, to be pushed back into the wire buffer storage over the entire length of the wire core, i.e., the hose pack.

Furthermore, an automatic welding apparatus in which the welding torch is fastened to a guide arm and the welding wire feed occurs at an angle relative to the welding torch is known from U.S. Pat. No. 6,486,438 B1. There, the welding torch, or torch handle, comprises a coupling device to which the hose pack or wire guide hose is coupled. The welding wire is returned to the welding torch via a wire core comprised of a flat spiral spring. In doing so, the wire core is conducted as far as to immediately in front of the contact tube in the welding torch.

In that case, it is disadvantageous that no wire buffer storage is realized with such a configuration and the welding wire will, thus, have to be pushed back over the entire hose pack at a change of direction of its conveyance.

Other welding torches including wire buffer storages are, for instance, described in JP 1122673 A, SU 1489941 A1, JP 55112176 A.

The object of the present invention, therefore, resides in providing a welding torch of the described kind, which has a simple and compact structure and exhibits an enhanced welding wire conveyance dynamic behavior. Disadvantages of the prior art are to be avoided or reduced.

The objects of the invention are achieved in that the wire buffer storage is arranged immediately after the region of connection of the hose pack within the torch body, and that the hose pack is arranged at an angle of up to 90° relative to the central axis of the welding torch. It is, thus, ensured in an advantageous manner that due to the curved course or course in the form of a loop, which is caused by a change in the radius of curvature or loop diameter, excess welding wire will be taken up such that the excess welding wire need no longer be conveyed back over the entire hose pack. This brings about a substantial improvement in the response behavior or dynamic behavior, since the wire buffer storage is arranged immediately in front of the drive unit within the torch body and, hence, only very short conveying paths will have be covered during the welding process at changes in speed or a reversal of the conveying direction. The wire buffer storage is, thus, realized directly in the welding torch with small dimensions and a reduced weight. It is, moreover, advantageous that the wire buffer storage is arranged within the torch body in a protected manner and no soiling can occur there. Due to its small structural size, a welding torch of this kind will be particularly suitable for robotic applications, being unlikely to substantially restrict the freedom of motion of the robot. By arranging the wire buffer storage immediately after the connection of the hose pack to the torch body and in front of the drive unit for conveying the welding wire, it is also ensured that the drive unit will operate in a substantially force-free manner within the welding torch, thus considerably enhancing the dynamic behavior of the conveyance of the welding wire. The welding wire may be surrounded by a wire core. By arranging the hose pack at an angle of up to 90° relative to the central axis of the welding torch, handling of the welding torch will be facilitated, particularly in robotic applications, because in this way the hose pack can be readily passed through below the third axis by rotation about the sixth axis.

In order to enable monitoring of the wire buffer storage, a sensor is advantageously provided to capture the welding wire stored in the wire buffer storage. Due to the arrangement of the wire buffer storage within the torch body of the welding torch, the sensor will also be protected by the torch body and less readily contaminated.

In an advantageous manner, a sensor is arranged in front of the drive unit, viewed in the conveying direction of the welding wire.

According to a variant embodiment of the welding torch, the wire core surrounding the welding wire is arranged in the end region within the torch body so as to be freely movable in the longitudinal direction. A change in the curved course of the welding wire will, thus, entail a change in the position of the free end of the wire core, which may be recorded in order to assess the amount of welding wire contained in the wire buffer storage.

To this end, a sensor may be provided for the detection of the movement of the wire core in the freely movable end region of the wire core.

According to a variant embodiment of the sensor, an indicator may be arranged in the freely movable end region of the wire core and the sensor may comprise at least one coil surrounding said indicator and having an inductance that is changeable by the position of the indicator. As a result, the position of the wire core and, hence, the condition of the wire buffer storage can be concluded from the detection of the inductance of the at least one coil.

According to another variant embodiment, the wire core may be fixed in the region of the drive unit. In this variant, the sensor will, for instance, detect the location of the curved course of the welding wire to capture the wire buffer storage, which may, for instance, be effected through an optical sensor.

Finally, it is also feasible that the wire core terminates immediately after the region of connection of the hose pack to the torch body, and that the welding wire is arranged in the region of the wire buffer storage within a flexible guide hose. This variant embodiment enables the simple exchange or replacement of the wire core as well as of the welding wire.

In order to facilitate the threading-in of the welding wire or wire core and, on the other hand, the limitation of a change in the curved course for limitation, limit elements may be arranged in the torch body to delimit the curved course of the unguided welding wire.

The connection of the hose pack to the torch body may be realized by a coupling device, which allows for the simple and rapid connection of the hose pack to the torch body. The coupling device may be comprised of a central connection, via which all lines such as the welding line, control lines, cooling circuit lines, a wire guide hose, the wire core and the welding wire are fed and connected.

Finally, it is advantageous if the hose pack is arranged to be adjustable relative to the torch body so as to enable a change of the amount of welding wire contained in the wire buffer storage by such an adjustment.

The present invention will be explained in more detail by way of the accompanying drawings, which illustrate exemplary embodiments of the welding torch. Therein:

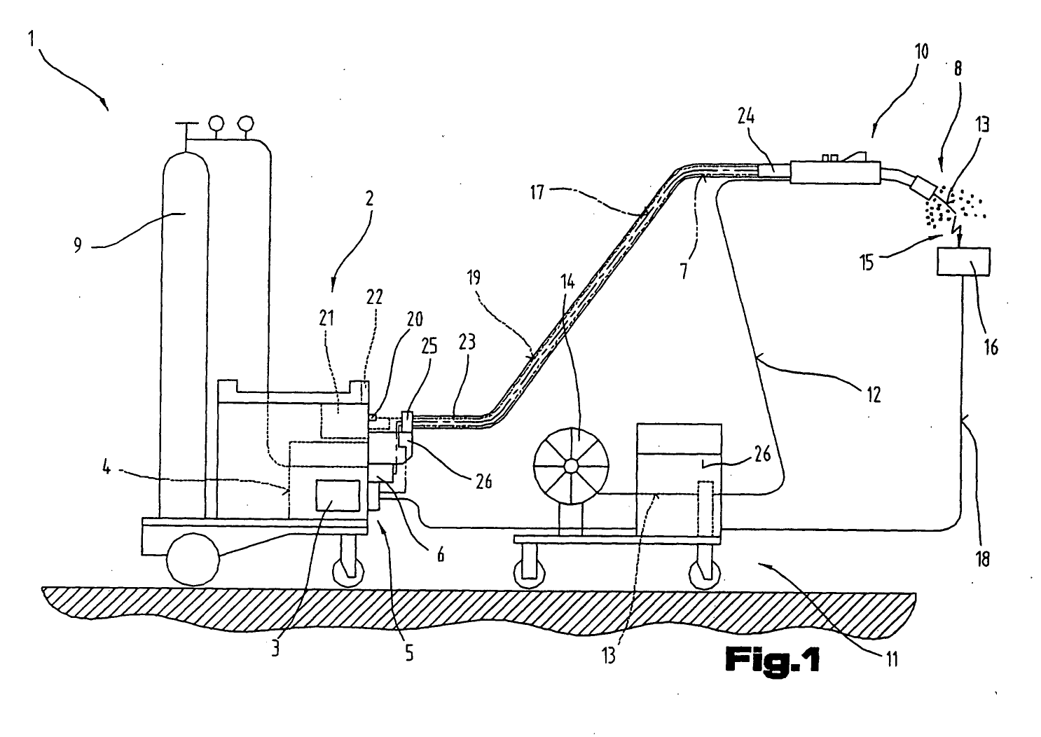

FIG. 1 is a schematic illustration of a welding machine or welding apparatus;

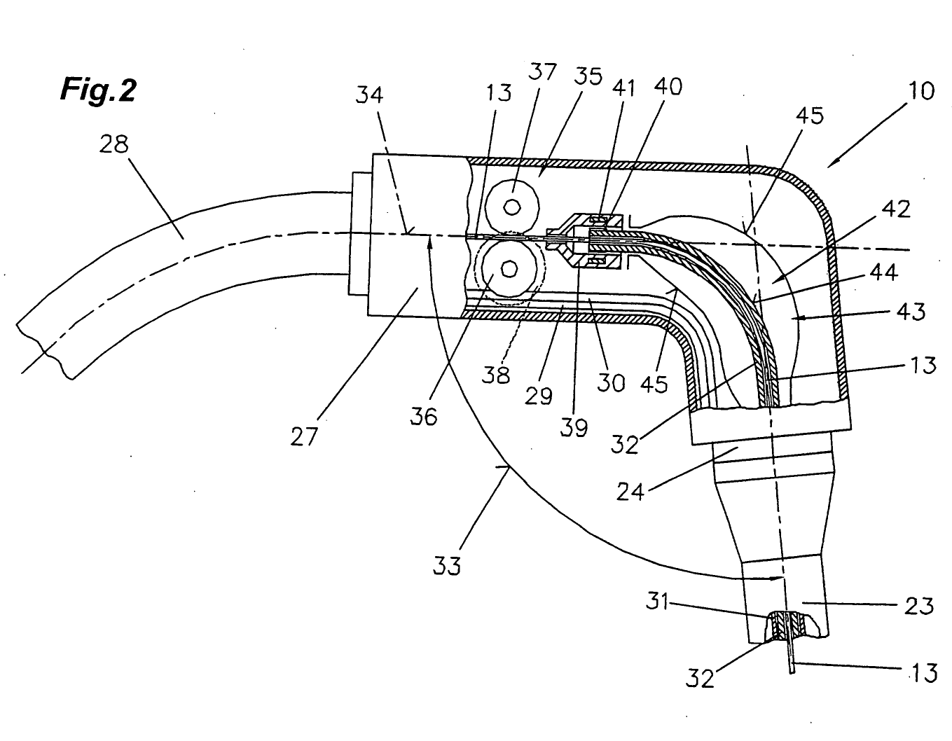

FIG. 2 is an elevational view of the welding torch with a wire buffer storage provided therein;

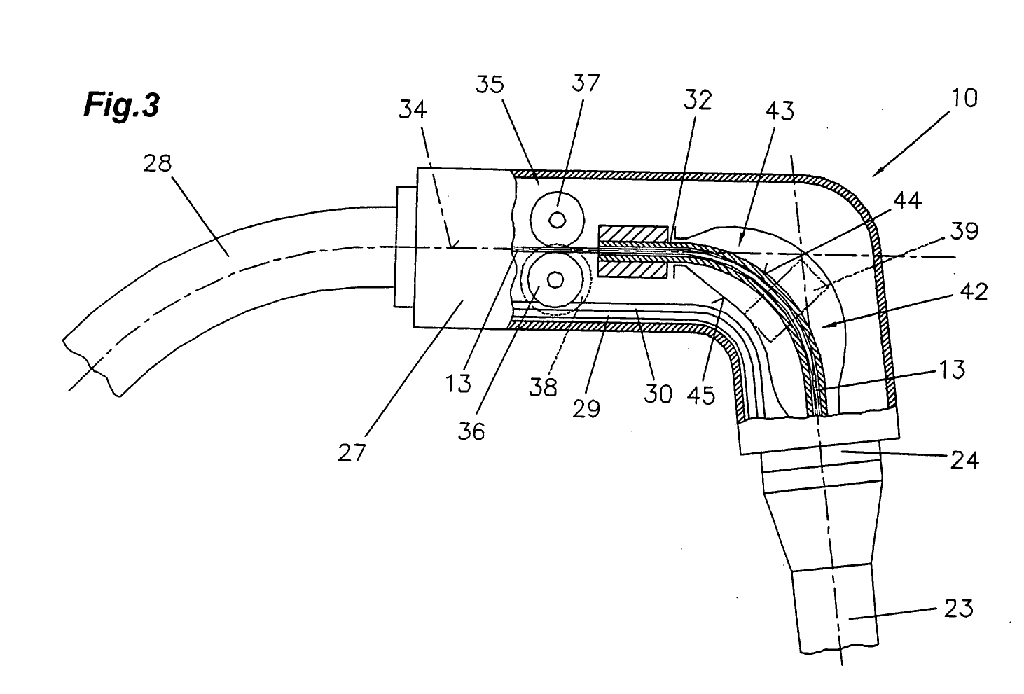

FIG. 3 depicts a further exemplary embodiment of the welding torch including a fixed wire core;

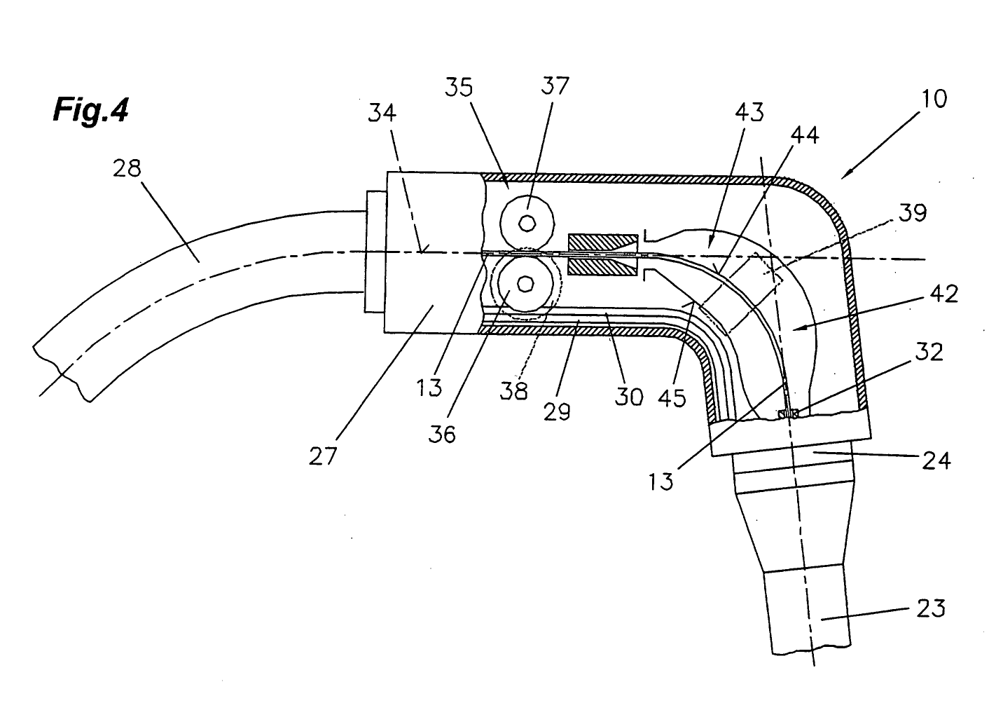

FIG. 4 illustrates an exemplary embodiment of the welding torch including a bare welding wire as a wire buffer storage;

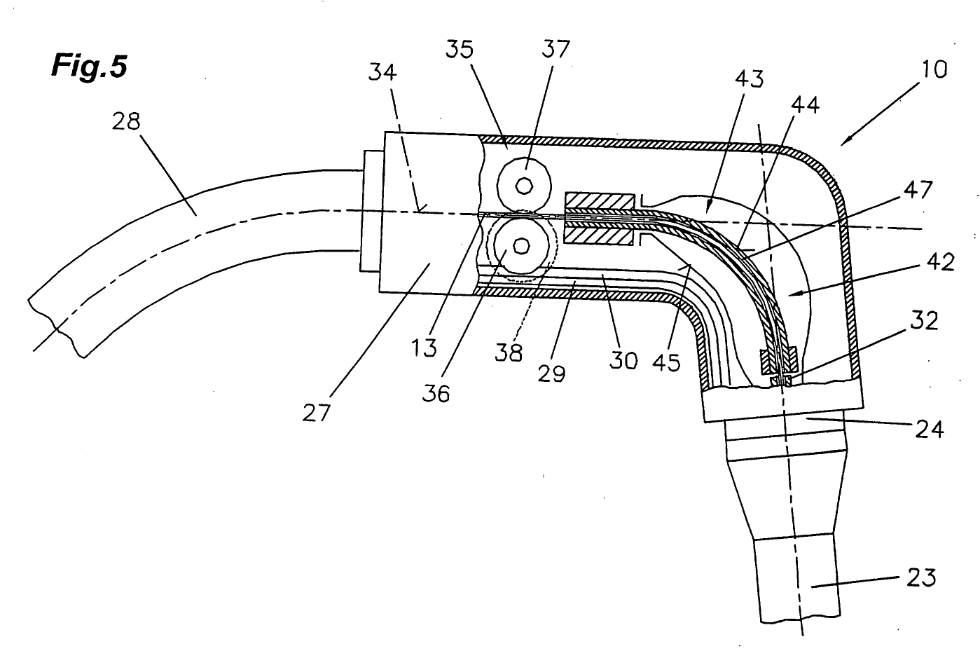

FIG. 5 depicts a welding torch including a guide hose as a wire buffer storage;

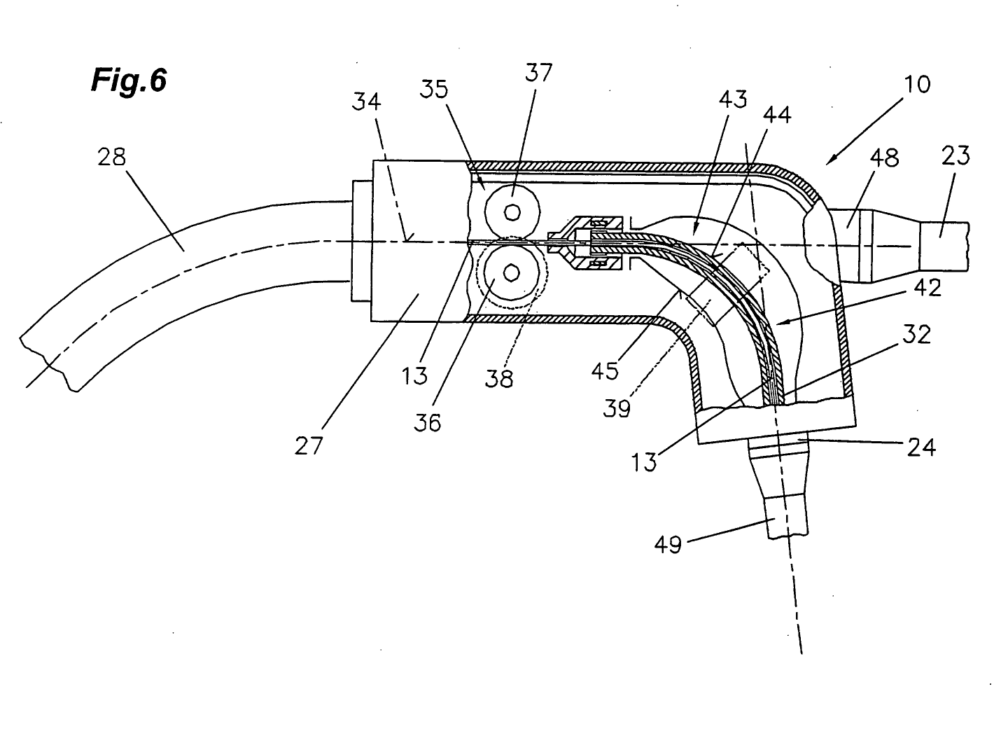

FIG. 6 illustrates a welding torch having two coupling devices;

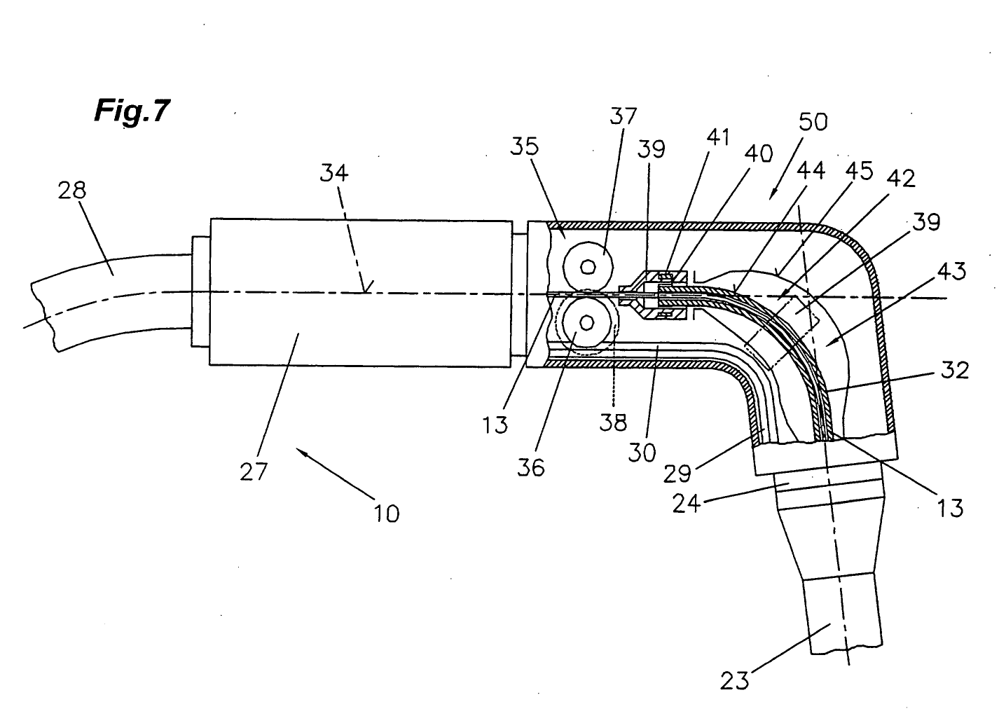

FIG. 7 depicts an exemplary embodiment of the welding torch including an adjustable coupling device; and

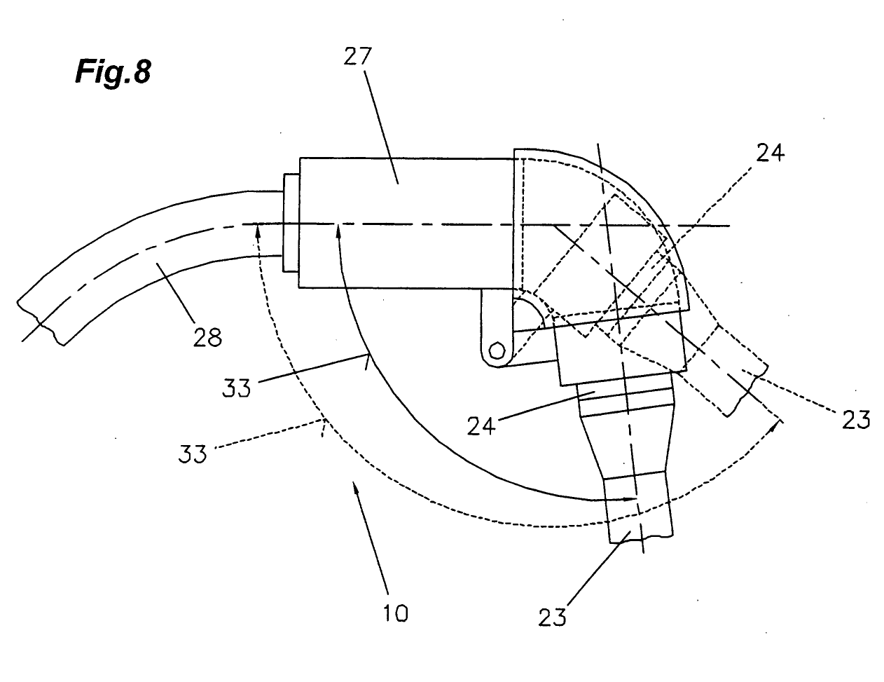

FIG. 8 is a schematic illustration of the welding torch including an adjustable torch body.

FIG. 1 depicts a welding apparatus 1 or welding plant for various welding processes or methods such as, e.g., MIG/MAG welding or WIG/TIG welding, or electrode welding methods, double-wire/tandem welding methods, plasma or soldering methods etc.

The welding apparatus 1 comprises a power source 2 including a power element 3, a control device 4, and a switch member 5 associated with the power element 3 and the control device 4, respectively. The switch member 5 and the control device 4 are connected to a control valve 6 arranged in a feed line 7 for a gas 8, in particular, a protective gas such as, e.g., carbon dioxide, helium or argon and the like, between a gas reservoir 9 and a welding torch 10, or torch.

Besides, a wire feeder 11 as is usually employed in MIG/MAG welding can also be activated by the control device 4, whereby additional material or welding wire 13 is fed from a feed drum 14, or wire coil, into the region of the welding torch 10 via a feed line 12. It is, of course, possible to integrate the wire feeder 11 in the welding apparatus 1 and, in particular, its basic housing, as is known from the prior art, rather than designing the same as an accessory device, as is illustrated in FIG. 1.

It is also feasible for the wire feeder 11 to supply the welding wire 13, or additional material, outside the welding torch 10 to the process site, to which end a non-consumable electrode is preferably arranged in the welding torch 10, as is usually the case with WIG/TIG welding.

The power for building up an electric arc 15, particularly an electric arc for welding, between the non-consumable electrode (not illustrated) and a workpiece 16 is supplied from the power element 3 of the power source 2 to the welding torch 10 and, in particular, electrode via a welding line 17, wherein the workpiece 16 to be welded, which is formed of several parts, is likewise connected with the welding apparatus 1 and, in particular, power source 2 via a further welding line 18, thus enabling a power circuit for a process to build up over the electric arc 15 or plasma jet formed.

To provide cooling of the welding torch 10, the welding torch 10 may be connected with a fluid reservoir and, in particular, water reservoir 21 by a cooling circuit 19 via an interposed flow control 20, whereby the cooling circuit 19 and, in particular, a fluid pump used for the fluid contained in the water reservoir 21, is started as the welding torch 10 is put into operation, in order to effect cooling of the welding torch 10.

The welding apparatus 1 further comprises an input and/or output device 22, via which the most different welding parameters, operating modes or welding programs of the welding apparatus 1 can be set and called, respectively. In doing so, the welding parameters, operating modes or welding programs set by the input and/or output device 22 are transmitted to the control device 4, which, in turn, will subsequently activate the individual components of the welding plant or welding apparatus 1, and predefine the respectively desired control values.

In the exemplary embodiment illustrated, the welding torch 10 is, furthermore, connected with the welding apparatus 1 or welding plant via a hose pack 23. The hose pack 23 accommodates the individual lines leading from the welding apparatus 1 to the welding torch 10. The hose pack 23 is connected with the welding torch 10 via a coupling device 24, whereas the individual lines arranged within the hose pack 23 are connected with the individual contacts of the welding apparatus 1 via connection sockets or plug-in connections. In order to ensure an appropriate strain relief of the hose pack 23, the hose pack 23 is connected with a housing 26 and, in particular, the basic housing of the welding apparatus 1 via a strain relief means 25. It is, of course, possible to use the coupling device 24 also for the connection to the welding apparatus 1.

Basically, it is to be noted that not all of the aforementioned components need be used or employed in the various welding methods or welding apparatus 1, such as, e.g., WIG devices or MIG/MAG apparatus or plasma devices. It is, for instance, feasible to design the welding torch 10 as an air-cooled welding torch 10.

FIG. 2 schematically illustrates the structure of a welding torch 10, which is comprised of a torch body 27 or torch handle and a tube bend 28 connected thereto. In a preferred manner, the tube bend 28 is detachably connected to the torch body 27. For the sake of clarity, only those parts of the illustrated welding torch 10 are shown, which are required to achieve the object of the invention. The remaining parts of the welding torch 10 may be arranged and designed in accordance with the prior art.

On the torch body 27 is provided the coupling device 24, to which the hose pack 23 may be connected. The coupling device 24 may be comprised of a central connection via which all lines such as the welding line 17, control lines 29, cooling circuit lines 30, the welding wire 13 fed through a wire guide hose 31 and a wire core 32 etc., are supplied and connected. The coupling device 24 is arranged on the torch body 27 in a manner that the hose pack 23 is angularly located, particularly at an angle 33 of up to 90° relative to the central axis 34 and, in particular, the longitudinal central axis of the welding torch 10. It is, of course, also possible to connect the hose pack 23 fixedly with the welding torch 10, i.e., without a coupling device 24.

Furthermore, a drive unit 35 is incorporated in the torch body 27. The drive unit 35 preferably serves to convey the welding wire 13, particularly at different wire conveying speeds and/or a forward/rearward wire conveyance of the welding wire 13. The drive unit 35 is comprised of at least one driving roller 36 and a pressure roller 37, whereby the driving roller 36 is connected with an electric motor 38 as schematically illustrated. It is, of course, also possible to replace the illustrated two-roller drive unit 35 with a four-roller drive unit.

Viewed in the normal conveying direction of the welding wire 13, a measuring means and, in particular, sensor 39 is arranged in front of the drive unit 35 to capture the movement of the wire core 32. To this end, the wire core 32 is not fixed in its end region in the exemplary embodiment illustrated. According to the illustrated variant, an indicator 40 is arranged on the end of the wire core 32. The sensor 39 comprises at least one coil 41, into which the wire core 32 immerses along with the indicator 40. A change in the position of the indicator 40 results in a change of the inductor of the coil 41. The location of the wire core 32 can, thus, be determined via a change in the inductance of the coil 41.

What is essential now is the fact that the wire core 32 conducting the welding wire 13 is unguidedly arranged immediately after the coupling device 24 and the wire core 32 follows a curved course 42, which means that a wire buffer storage 43 is formed by said curved course 42. It is the task of the wire buffer storage 43 to take up, or deliver, excess welding wire 13. A change in the central radius 44 of the curved course 42, at the same time, causes a longitudinal movement of the end of the wire core 32. The sensor 39, for instance, via a change in the inductance of the coil 41, enables the detection of the condition of the wire buffer storage 43 and the conclusion of the radius 44 of the curved course 42.

Basically, it should be mentioned in this respect that with such a wire conveyance a further drive unit is usually arranged in the welding apparatus 1, or in the wire feeder 11, said further drive unit drawing the welding wire 13 off the wire coil or storage drum 14 and conveying the same via the hose pack 23 into the torch body 27 (not illustrated). The drive unit 35 provided in the welding torch 10 serves to draw the welding wire 13 from the hose pack 23 and pass it on to the welding site via the tube bend 28. If the drive unit in the welding apparatus 1, or in the wire feeder 11, conveys more welding wire 13 than is delivered by the drive unit 35 provided in the welding torch 13, the excess welding wire may be taken up by the wire buffer storage 43, whereby its radius 44 will be reduced. At the same time, the end of the wire core 32 and, in particular, the indicator 40 are pushed forward, i.e., in the direction to the drive unit 35. In the reverse sense, it may happen that more welding wire 13 is conveyed to the welding site by the drive unit 35 than is fed into the hose pack 23 by the drive unit provided in the welding apparatus 1, or in the wire feeder 11, such that the radius 44 of the curved course 42 will be increased, with the end of the wire core 32 moving away from the drive unit 35.

Such an intervention of the wire buffer storage 43 will, in particular, occur if and when the welding wire 13 is conveyed at a temporally varying speed, or a forward/rearward movement of the welding wire 13 is carried out, during a welding process, so that a short-term welding wire storage in, or withdrawal from, the wire buffer storage 43 will take place. Thus, an enormous improvement in the response behavior during the wire conveyance at different wire conveying speeds, or a a forward/rearward movement, will be reached in an advantageous manner, since the wire buffer storage 43 is arranged immediately behind the drive unit 35 and, hence, hardly any frictional losses will occur. Even a slack of the welding wire 13 will be taken up by the wire buffer storage 43 at a reversal of direction so as to enable a very rapid reversal of direction.

It is, furthermore, schematically illustrated that the other lines leading from the hose pack 23 to the welding torch 10 are conducted laterally past the drive unit 35 and may, hence, be directed into the tube bend 28.

In order to enable the threading in of the wire core 32 and the automatic threading in of the welding wire 13, it is feasible to arrange limit elements 45 within the torch body 27, as is schematically indicated, so that the wire core 32 will be guided as it is threaded into the sensor 39, and the welding wire 13 will, hence, be positioned accordingly. After this, an adjustment may, for instance, be effected prior to the start of the welding process, in order to orient the wire core 32 in a manner that a central position of the curved course 42 within the wire buffer storage 43 will result.

FIG. 3 illustrates an exemplary embodiment in which the wire core 32 is fixed in the region of the drive unit 35, thus preventing the end of the wire core 32 from carrying out a longitudinal movement. The wire buffer storage 43 in this case is merely realized by the curved course 42, which causes more or less welding wire 13 to be stored in the wire buffer storage 43 either by increasing or by reducing the radius 44. The wire core 32 may also be fixed in the region of the coupling device 24, thus preventing the wire core 32 from being inserted into the hose pack 23.

This configuration calls for a change in the construction of the measuring means, i.e. sensor 39, as compared to FIG. 2. It is, for instance, feasible to connect a lever arm or a movably mounted roller with the bare wire core 32, i.e., the curved course 42, which lever or roller is, for instance, coupled with a potentiometer or an incremental probe or the like. It is also feasible to realize an optical monitoring of the radius 44 of the curved course 42. To this end, the sensor 39 may be comprised of light-sensitive and light-emitting elements such that the radius 44 of the curved course 42 within the wire buffer storage 43 can be concluded from the coverage of the optical elements by the wire core 32.

In the exemplary embodiment represented in FIG. 4, the wire core 32 terminates immediately downstream of the coupling device 24. The welding wire 13 runs barely as far as to the drive unit 35, again forming a curved course 42 with a radius 44. By appropriately designing the measuring means or sensor 39, the condition of the wire buffer storage 43 can again be readily detected and evaluated. It is, for instance, feasible to use a movably mounted roller or an optical monitoring means as a sensor 39.

Furthermore, it is also feasible, as in accordance with FIG. 5, to configure the welding torch 10 in a manner that the wire core 32 terminates in the region of the coupling device 24 and the welding wire 13 passes into a guide hose 47 arranged within the welding torch 10, which means that a flexible guide hose 47 following the loop-shaped course is arranged in the welding torch 10 and the wire core 32 may, thus, terminate in the region of the coupling device 24. This enables the simple exchange and the simple and automatic replacement both of the wire core 32 and of the welding wire 13. The configuration of the guide hose 47 and the detection of the radius 44, i.e., the condition of the wire buffer storage 43, may be carried out in accordance with the previously described exemplary embodiments of the sensors 39.

According to another embodiment, as in accordance with FIG. 6, it is, moreover, feasible to arrange a further coupling device 48 and realize a distribution of the lines required for a welding process. In doing so, the welding wire 13 is angularly fed to the welding torch 10 as illustrated in FIGS. 2 to 5, whereas the other lines are coupled centrically to the longitudinal axis of the welding torch 10, which means that the welding wire 13 is, for instance, fed and connected to the coupling device 24 of the welding torch 10 via a separate wire guide hose 49 that ends at the coupling device 24, whereas the other lines are connected to the further coupling device 48 via the hose pack 23. The welding wire 13 is, thus, guided to the welding torch 10 independently of the other lines running in the hose pack 23. In the external wire guide hose 49, the wire core 32 is again arranged to follow a curved course 42 so as to form a wire buffer storage 43.

FIG. 7 depicts a further exemplary embodiment, in which the drive unit 35 constitutes a separate module and, in particular, drive module 50. The drive unit 35 in this case is pluggably connected with the torch body 27, or even directly with the tube bend 28, as is known from the prior art.

The connection of the drive module 50 to the hose pack 23 in this case may be realized in accordance with the previously described FIGS. 1 to 6. The drive unit 35 is arranged in the drive module 50, with the welding wire 13 following a curved course 42 at a radius 44 to provide the wire buffer storage 43. The connection with the hose pack 23 may be realized via the coupling device 24 or 48. It goes without saying that the hose pack 23 and, in particular, the lines fed therein may be directly connected to the drive module 50.

It is, furthermore, feasible in the above-described variant embodiments that the coupling device 24 is arranged on a housing part of the torch body 27, that is adjustable relative to the other parts of the torch body 27, thus allowing the angular position and, in particular, the angle 33 to be varied in order to render feasible an adjustable connection of the hose pack 23. This configuration offers the advantage that, by such an adjustment, direct influence may be exerted on the configuration of the curved course 42, i.e., on the radius 44 of the welding wire 13, thus enabling variations of the size of the wire buffer storage 43. Such a configuration is shown in FIG. 8, which illustrates a second position of the torch body 27 in broken lines.

1. A welding torch (10) including a torch body (27) and a drive unit (35) for conveying a welding wire (13), particularly for different wire-conveying speeds or a forward/rearward wire conveyance, as well as a hose pack (23) connected to the torch body (27) at an angle relative to a central axis (34) of said welding torch (10), wherein a wire core (32) for the welding wire (13), or the welding wire (13) itself, follows a curved course (42) to form a wire buffer storage (43), and the amount of welding wire (13) contained in the wire buffer storage (43) is adjustable by a change of said curved course, wherein the wire buffer storage (43) is arranged immediately after the region of connection of the hose pack (23) within the torch body (27), and that the hose pack (23) is arranged at an angle (33) of up to 900 relative to the central axis (34) of the welding torch (10)

2. A welding torch according to claim 1, wherein a sensor (39) is provided to capture the welding wire (13) stored in the wire buffer storage (43).

3. A welding torch according to claim 2, wherein a sensor (39) is arranged in front of the drive unit (35), viewed in the conveying direction of the welding wire (13).

4. A welding torch according to claim 1, wherein the wire core (32) is arranged in the end region within the torch body (27) so as to be freely movable in the longitudinal direction.

5. A welding torch according to claim 4, wherein a sensor (39) is arranged to detect the movement of the wire core (32) in the freely movable end region of the wire core (32).

6. A welding torch according to claim 5, wherein an indicator (40) is arranged in the freely movable end region of the wire core (32), and that the sensor (39) comprises at least one coil (41) surrounding said indicator (40) and having an inductance that is changeable by the position of the indicator (40).

7. A welding torch according to claim 1, wherein the wire core (32) is fixed in the region of the drive unit (35).

8. A welding torch according to claim 1, wherein the wire core (32) terminates immediately after the region of connection of the hose pack (23) to the torch body (27), and that the welding wire (13) is subsequently arranged to extend barely as far as to the drive unit (35).

9. A welding torch according to claim 1, wherein the wire core (32) terminates immediately after the region of connection of the hose pack (23) on the torch body (27), and that the welding wire (13) is arranged in a flexible guide hose (47) within the wire buffer storage (43).

10. A welding torch according to claim 1, wherein limit elements (45) are arranged in the torch body (27) to delimit the curved course of the unguided welding wire (13)

11. A welding torch according to claim 1, wherein the connection of the hose pack (23) to the torch body (27) is realized by a coupling device (24).

12. A welding torch according to claim 1, wherein the hose pack (23) is arranged to be adjustable relative to the torch body (27) so as to enable a change of the amount of welding wire (13) contained in the wire buffer storage (43) by such an adjustment.
